(19) United States
(12) Patent Application Publication
(10) Pub. No.: US 2025/0005647 A1
(43) Pub. Date: Jan. 2, 2025

(54) RECOMMENDATION DEVICE

(71) Applicant: NTT DOCOMO, INC., Tokyo (JP)

(72) Inventors: Kunihiro AIBA, Chiyoda-ku (JP); Sohei ONO, Chiyoda-ku (JP); Wataru AKASHI, Chiyoda-ku (JP); Sho MAEOKI, Chiyoda-ku (JP)

(73) Assignee: NTT DOCOMO, INC., Tokyo (JP)

(21) Appl. No.: 18/709,656

(22) PCT Filed: Oct. 5, 2022
(86) PCT No.: PCT/JP2022/037338

§ 371 Date: May 13, 2024

(30) Foreign Application Priority Data
Nov. 15, 2021 (JP) 2021-185393

(51) Int. Cl. G06Q 30/0601

(52) U.S. Cl. CPC G06Q 30/0631

(57) ABSTRACT

A recommendation device includes a storage unit storing a content feature vector and a user feature vector, an acquisition unit acquiring information indicating a plurality of favorite contents and preference information indicating the preference of a user, a learning unit performing learning such that the position of the user feature vector and the position of the content feature vector of the plurality of favorite contents approach each other, a correction unit correcting the position of the user feature vector by using weighting based on the preference information, a computation unit computing a score of each of the plurality of contents on the basis of a separation distance between the position of the user feature vector and the position of the content feature vector, and an output unit outputting a recommendation result of a content selected on the basis of the score.

### TECHNICAL FIELD

One aspect of the present disclosure relates to a recommendation device recommending a content to a user.

### BACKGROUND ART

In online shopping or the like, a recommendation system recommending a product or the like according to a user is known. Such a recommendation system, for example, extracts information relevant to the interest of the user by using a log or the like of the click or the page transition of the user according to the selection of the product. Then, the recommendation system sorts the product by using the information relevant to the interest of the user, and recommends the sorted product to the user.

Patent Literature 1 discloses a system in which feature amount data of a content is generated and retained as a multidimensional vector, clustering processing is performed by using feature amount data of a content selected on the basis of the preference of a user to generate learning result data indicating the preference of the user as a multidimensional vector, and feature amount data of which a Euclidean distance with respect to the learning result data is within a predetermined distance is extracted to retrieve the content.

### CITATION LIST

### Patent Literature

Patent Literature 1: Japanese Unexamined Patent Publication No. 2011-060182

### SUMMARY OF INVENTION

### Technical Problem

The user, for example, may search for the content such as a product on the basis of preference information different for each of the users, such as the quality of an appearance or the quality of product information (a specification). It is difficult for a person other than the user (for example, a third party) to suitably grasp the preference information of the user. Accordingly, it is also difficult to sort and recommend the content by using the preference information. Therefore, a mechanism capable of suitably grasping the preference information different for each of the users is required.

Therefore, an object of one aspect of the present disclosure is to

provide a recommendation device capable of recommending a content matching the preference of a user by suitably grasping preference information different for each of the users.

### Solution to Problem

A recommendation device according to one aspect of the present

disclosure includes: a storage unit storing a content feature vector indicating a feature of a content for each of a plurality of contents, and storing a user feature vector indicating a feature of a user; an acquisition unit acquiring information indicating a plurality of favorite contents selected by the user from the plurality of contents, and preference information indicating preference of the user according to each of the plurality of favorite contents, which is input by the user comparing the plurality of favorite contents with each other; a learning unit performing learning such that in a vector space indicating the content feature vector of the plurality of contents and the user feature vector, a position of the user feature vector and a position of the content feature vector of the plurality of favorite contents approach each other; a correction unit correcting the position of the user feature vector in the vector space by using weighting based on the preference information; a computation unit computing a score of each of the plurality of contents on the basis of a separation distance between the position of the user feature vector and the position of the content feature vector of the plurality of contents in the vector space; and an output unit outputting a recommendation result of a content selected on the basis of the score.

In the recommendation device according to one aspect of the present disclosure, the information indicating the plurality of favorite contents selected by the user is acquired, and the preference information according to each of the plurality of favorite contents, which is input by the user comparing the plurality of favorite contents with each other, is acquired. Further, the learning is performed such that in the vector space, the position of the user feature vector and the position of the content feature vector of the plurality of favorite contents approach each other, and the position of the user feature vector is corrected by using the weighting based on the preference information. Then, the score is computed on the basis of the separation distance between the position of the user feature vector and the position of each of the content feature vectors, and the recommendation result of the content selected on the basis of the score is output. As described above, since the preference information of the user is acquired by the user selecting the favorite contents from the plurality of contents and comparing the favorite contents with each other, it is possible to suitably grasp the preference information different for each of the users. Then, in addition to performing the learning such that the position of the user feature vector and the position of the content feature vector of the favorite content approach each other, by correcting the position of the user feature vector with the weighting based on the preference information described above, and selecting a recommendation target on the basis of the separation distance in the vector space, it is possible to sufficiently reflect the preference of the user, and recommend the content matching the preference of the user.

### Advantageous Effects of Invention

According to one aspect of the present disclosure, it is possible to provide the recommendation device capable of recommending the content matching the preference of the user by suitably grasping the preference information different for each of the users.

### BRIEF DESCRIPTION OF DRAWINGS

FIG. 1 is a diagram illustrating a function configuration of a recommendation device according to an embodiment.

FIG. 2 is a diagram illustrating a feature vector and a vector space.

FIG. 3 is a diagram illustrating an example of a product selection screen.

FIG. 4 is a diagram illustrating an example of a comparison screen.

FIG. 5 is a diagram illustrating correction of a position of a user feature vector.

FIG. 6 is a flowchart illustrating processing executed by the recommendation device.

FIG. 7 is a diagram illustrating a hardware configuration of the recommendation device.

### DESCRIPTION OF EMBODIMENTS

Hereinafter, an embodiment of the present invention will be described in detail with reference to the attached drawings. In the description of the drawings, the same reference numerals will be applied to the same or equivalent elements, and the repeated description will be omitted.

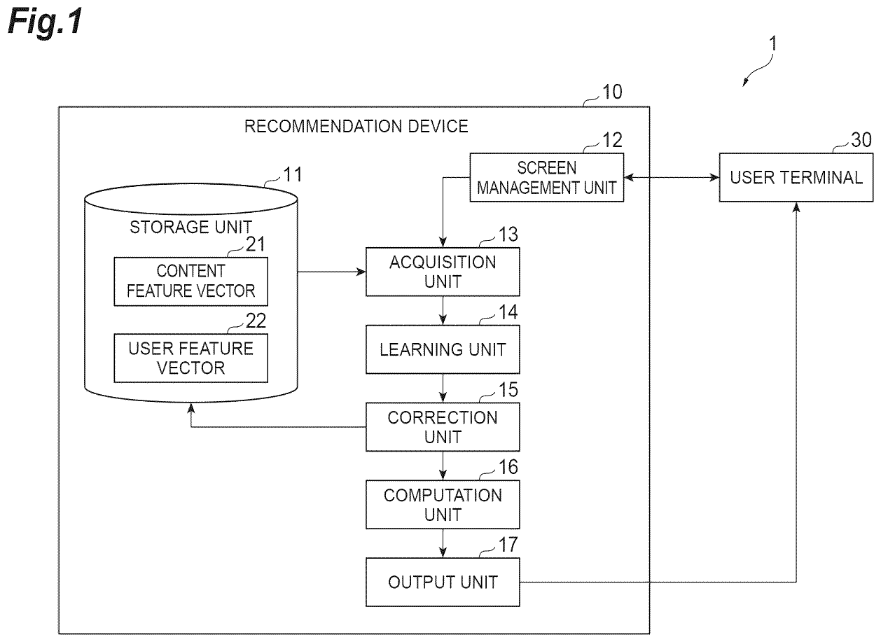

FIG. 1 is a diagram illustrating a function configuration of a recommendation device 10 according to this embodiment. The recommendation device 10 is a device recommending a content according to the preference of each user to the user (that is, distributing the content to a user terminal 30 of the user). The content, for example, indicates any tangible object or intangible object that is traded with a cost or without a cost, and is a concept including the provision of a product and a service. The recommendation device 10 selects a content to be recommended to the user by considering preference information different for each of the users. The preference information different for each of the users is information that can be perceived differently or valued differently in accordance with the user. Examples of the preference information different for each of the users include an appearance, product information (a specification), and the like, but are not limited thereto.

The recommendation device 10 learns the preference of the user on the basis of the information of a plurality of favorite contents selected by the user, and the preference information according to each of the plurality of favorite contents input by the user. The favorite content indicates a content that the user likes, among a plurality of contents belonging to the same category (for example, a smart phone or the like). The recommendation device 10 selects the content to be recommended to the user such that the content according to the preference of the user is a distribution target.

As illustrated in FIG. 1, a recommendation system 1 is configured by including a recommendation device 10 and a user terminal 30. The user terminal 30 is a communication terminal having a communication function, and for example, is a smart phone, a tablet terminal, a personal computer, or the like. The user terminal 30 is connected to the recommendation device 10 via a network such that communication is available. The user terminal 30 has at least a function of displaying various screens, a function of receiving input from the user, a function of transmitting information input from the user to the recommendation device 10, a function of receiving the distribution of the content, which is a recommendation target, from the recommendation device 10, and a function of displaying the content. In FIG. 1, only one user terminal 30 is illustrated, but in practice, the recommendation system 1 includes a plurality of user terminals 30 of each of the users.

As illustrated in FIG. 1, the recommendation device 10 includes a storage unit 11, a screen management unit 12, an acquisition unit 13, a learning unit 14, a correction unit 15, a computation unit 16, and an output unit 17.

The storage unit 11 stores a content feature vector 21 indicating the feature of the content for each of the plurality of contents, and stores a user feature vector 22 indicating the feature of the user. In this embodiment, the plurality of contents will be described on the assumption that the contents are a smart phone.

For example, the storage unit 11 stores an appearance feature vector as the content feature vector 21 indicating the feature of the appearance for each of the plurality of contents. The appearance is the outer appearance of the product. In addition, the storage unit 11 stores a user feature vector in an appearance vector space as the user feature vector 22. The appearance vector space is a vector space indicating the appearance feature vector of the plurality of contents.

For example, the storage unit 11 stores a detailed statement feature vector as the content feature vector 21 indicating the feature for the detailed statement of each of the plurality of contents. The detailed statement is a text for describing product details (the specification). Examples of the detailed statement include a dimension, a weight, an on-board function, and the like, but are not limited thereto. In addition, the storage unit 11 stores a user feature vector in a detailed statement vector space as the user feature vector 22. The detailed statement vector space is a vector space indicating the detailed statement feature vector of the plurality of contents.

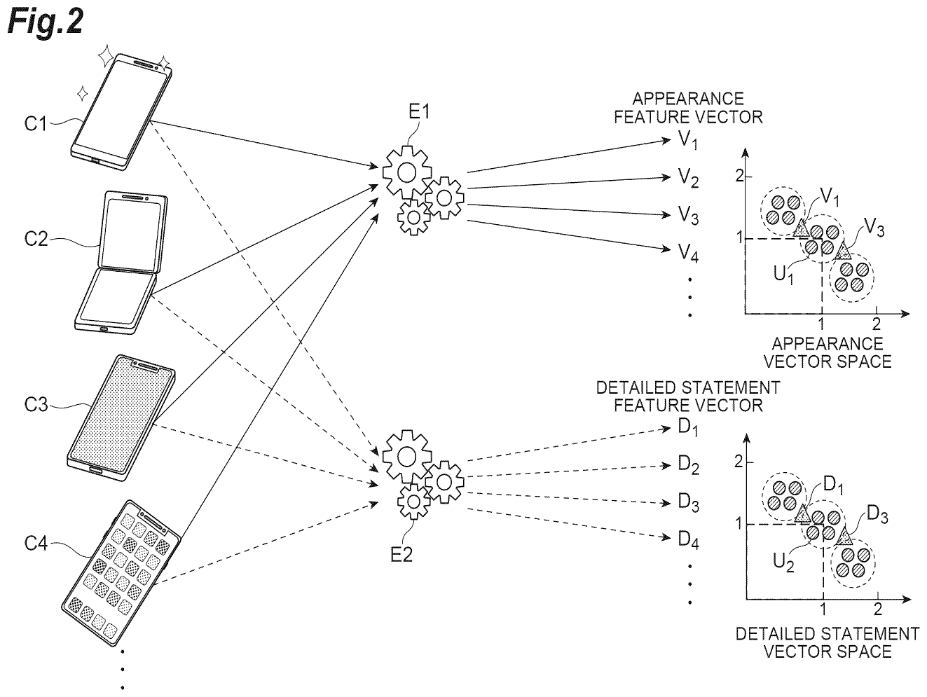

FIG. 2 is a diagram illustrating the feature vector and the vector space. An image recognition model E1, for example, vectorizes an input image. The image recognition model E1, for example, is a convolutional neural network (CNN) or the like. The image recognition model E1 receives the image of each of the plurality of contents and outputs the appearance feature vector. In an example, the appearance feature vector is the intermediate layer output of the CNN. For example, the image recognition model E1 receives the image of each of smart phones C1, C2, C3, and C4 and outputs each of appearance feature vectors V₁, V₂, V₃, and V₄. The appearance vector space illustrated in FIG. 2 indicates the appearance feature vectors V₁ and V₃, and the user feature vector U₁, as some examples. As described above, the appearance feature vector and the user feature vector are allocated onto the same appearance vector space.

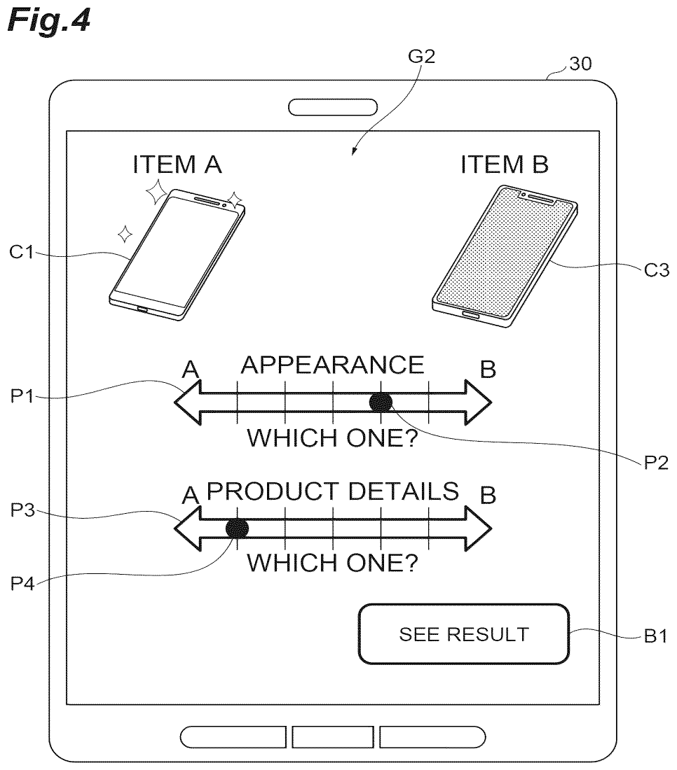

A natural language model E2 vectorizes an input natural language. The natural language model E2, for example, is bidirectional encoder representations from transformers (BERT) or the like. The natural language model E2 receives the natural language of each of the plurality of contents and outputs the detailed statement feature vector. In an example, the detailed statement feature vector is a document vector based on the BERT. For example, the natural language model E2 receives the detailed statement of each of the smart phones C1, C2, C3, and C4 and outputs each of detailed statement feature vectors D₁, D₂, D₃, and D₄. The detailed statement vector space illustrated in FIG. 4 indicates the detailed statement feature vectors D₁ and D₃, and the user feature vector U₂, as some examples. As described above, the detailed statement feature vector and the user feature vector are allocated onto the same detailed statement vector space.

Returning to FIG. 1, the screen management unit 12 manages various screens displayed on the user terminal 30. The screen management unit 12 manages a product selection screen for selecting the favorite content from the plurality of contents, a comparison screen for comparing the plurality of favorite contents with each other, and the like. The screen management unit 12 acquires information from the user terminal 30 via various screens, and outputs the acquired information to the acquisition unit 13.

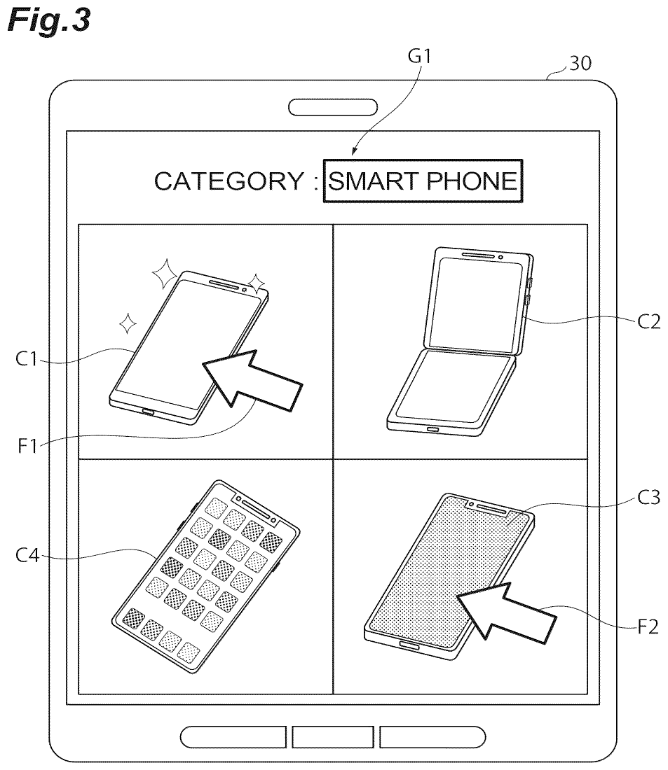

FIG. 3 is a diagram illustrating an example of a product selection screen G1. The product selection screen G1 is a screen that is displayed on the user terminal 30 and is for selecting the favorite content from the plurality of contents. The product selection screen G1 may display a page, a pop-up window, or the like for ascertaining more detailed information (for example, the appearance, the detailed statement, and the like) for each of the plurality of contents.

On the product selection screen G1, the smart phones C1, C2, C3, and C4 are displayed as the plurality of contents. The user terminal 30 receives a manipulation from the user selecting the plurality of favorite contents from the plurality of contents. For example, the user terminal 30 receives a manipulation from the user selecting the smart phones C1 and C3 on the product selection screen G1.

On the product selection screen G1, icons F1 and F2 indicating the selected smart phones C1 and C3, respectively, are displayed. The user terminal 30 transmits information indicating the selected smart phones C1 and C3 to the recommendation device 10. The recommendation device 10 receives the information indicating the smart phones C1 and C3.

FIG. 4 is a diagram illustrating an example of a comparison screen G2. The comparison screen G2 is a screen that is displayed on the user terminal 30 and is for comparing the plurality of favorite contents with each other. For example, the plurality of favorite contents are the content selected on the product selection screen G1 illustrated in FIG. 3. The comparison screen G2 may display a page, a pop-up window, or the like for ascertaining more detailed information (for example, the appearance, the detailed statement, and the like) for each of the plurality of contents.

On the comparison screen G2, the plurality of smart phones C1 (an item A) and C3 (an item B) are displayed as the plurality of favorite contents. In addition, on the comparison screen G2, an input interface P1 for inputting preference information relevant to the appearance, an input interface P3 for inputting preference information relevant to the product details (the detailed statement), and a result display button B1 are displayed.

The user terminal 30 receives a manipulation from the user inputting the preference information for each of the plurality of favorite contents. More specifically, the user terminal 30 receives the manipulation from the user inputting the preference information for which of the plurality of favorite contents is more preferred.

For example, the user terminal 30 receives a manipulation of inputting appearance preference information as the preference information relevant to the appearance for each of the smart phones C1 and C3. In an example, the user terminal 30 receives a manipulation of evaluating which appearance of the smart phones C1 and C3 is more preferred in n levels (for example, n=5) via the input interface P1.

The input interface P1 displays a pointer P2 indicating the appearance preference information input by the user comparing the smart phones C1 and C3 with each other. The position of the pointer P2 in the input interface P1 is at the fourth level of the 5-level evaluation from the smart phone C1 toward the smart phone C3. The position of the pointer P2 indicates that the user prefers the appearance of the smart phone C3 to the smart phone C1. In addition, the position of the pointer P2 indicates weighting wᵥ based on the appearance preference information. For example, the position of the pointer P2 indicates that the weighting wᵥ based on the appearance preference information is 4 corresponding to the fourth level of the 5-level evaluation.

For example, the user terminal 30 receives a manipulation of inputting detailed statement preference information as the preference information relevant to the detailed statement for each of the smart phones C1 and C3. In an example, the user terminal 30 receives a manipulation of evaluating which detailed statement of the smart phones C1 and C3 is more preferred in 5 levels via the input interface P3.

The input interface P3 displays a pointer P4 indicating the detailed statement preference information input by the user comparing the smart phones C1 and C3 with each other. The position of the pointer P4 in the input interface P3 is at the first level of the 5-level evaluation from the smart phone C1 toward the smart phone C3. The position of the pointer P4 indicates that the user prefers the detailed statement of the smart phone C1 to the smart phone C3. In addition, the position of the pointer P4 indicates weighting w_{d} based on the detailed statement preference information. For example, the position of the pointer P4 indicates that the weighting w_{d} based on the detailed statement preference information is 1 corresponding to the first level of the 5-level evaluation.

The user terminal 30 transmits the preference information according to each of the smart phones C1 and C3 to the recommendation device 10. In an example, the user terminal 30 transmits the appearance preference information and the detailed statement preference information as the preference information to the recommendation device 10.

The result display button B1 is a button for displaying a recommendation result. For example, in a case where the user presses the result display button B1, the recommendation result according to the preference of the user is displayed on the user terminal 30. The user terminal 30 may transmit the preference information to the recommendation device 10 with the press of the result display button B1 as a trigger.

Returning to FIG. 1, the acquisition unit 13 acquires the information indicating the plurality of favorite contents selected by the user from the plurality of contents. For example, the acquisition unit 13 acquires information indicating two favorite contents as the information indicating the plurality of favorite contents. For example, the acquisition unit 13 may acquire the information indicating the plurality of favorite contents on the basis of the input of the user on the product selection screen G1.

The acquisition unit 13 acquires the preference information indicating the preference of the user according to each of the plurality of favorite contents, which is input by the user comparing the plurality of favorite contents with each other. For example, the acquisition unit 13 acquires the appearance preference information as the preference information relevant to the appearance. In addition, the acquisition unit 13 acquires the detailed statement preference information as the preference information relevant to the detailed statement. For example, the acquisition unit 13 may acquire the preference information according to each of the plurality of favorite contents on the basis of the input of the user on the comparison screen G2.

The learning unit 14 performs learning such that in the vector space indicating the content feature vector of the plurality of contents and the user feature vector, the position of the user feature vector and the position of the content feature vector of the plurality of favorite contents approach each other. The learning unit 14, for example, adjusts the position of the user feature vector in each of the appearance vector space and the detailed statement vector space by using a technology such as collaborative metric learning (CML).

For example, the learning unit 14 performs learning such that in the appearance vector space, the position of the user feature vector and the position of the content feature vector of the smart phones C1 and C3, which are the plurality of favorite contents acquired by the acquisition unit 13, approach each other. In addition, the learning unit 14 may perform learning such that in the appearance vector space, the position of the user feature vector and the position of the content feature vector of the smart phones other than the smart phones C1 and C3 (for example, the smart phones C2 and C4) are separated from each other.

For example, the learning unit 14 performs learning such that in the detailed statement vector space, the position of the user feature vector and the position of the content feature vector of the smart phones C1 and C3, which are the plurality of favorite contents acquired by the acquisition unit 13, approach each other. The learning unit 14 may perform learning such that in the detailed statement vector space, the position of the user feature vector and the position of the content feature vector of the smart phones other than the smart phones C1 and C3 (for example, the smart phones C2 and C4) are separated from each other.

The correction unit 15 corrects the position of the user feature vector in the vector space by using the weighting based on the preference information. For example, the correction unit 15 corrects the position of the user feature vector to a position that is an internally dividing point between the positions of the content feature vectors of the two favorite contents and considers the weighting based on the preference information.

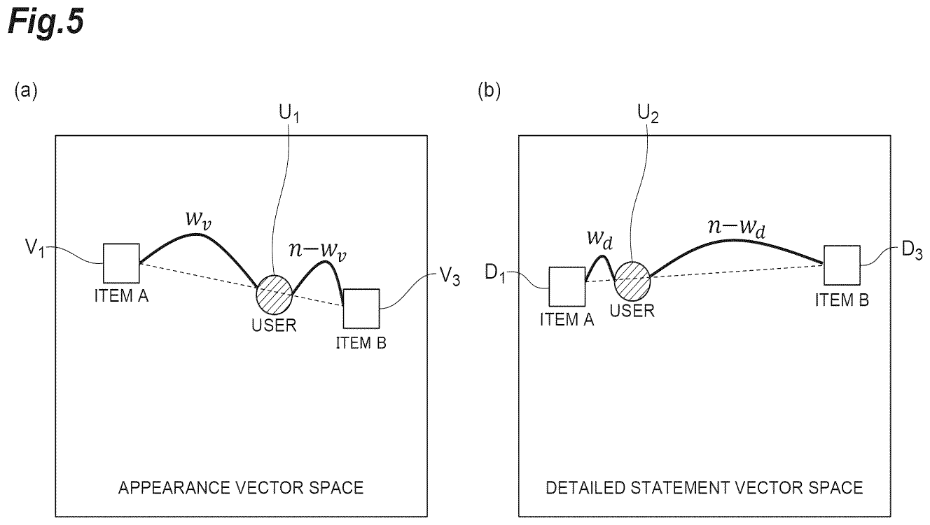

FIG. 5 is a diagram illustrating the correction of the position of the user feature vector. FIG. 5(a) is a diagram illustrating the correction of the position of the user feature vector in the appearance vector space. In FIG. 5(a), “ITEM A” indicates the position of the appearance feature vector V₁ of the smart phone C1, the “ITEM B” indicates the position of the appearance feature vector V₃ of the smart phone C3, and the “USER” indicates the position of the user feature vector U₁.

For example, the correction unit 15 corrects the position of the user feature vector U₁ in the appearance vector space by using the weighting wᵥ based on the appearance preference information. As an example, the correction unit 15 corrects the position of the user feature vector U₁ in the appearance vector space by using Expression (1) described below.

$$\{ {w}_{v} * {V}_{1} + ( n - {w}_{v} ) * {V}_{3} \} / n \qquad ( 1 )$$

Here, n is the total number of levels (for example, n=5) in the n-level evaluation of the appearance preference information. wᵥ is a level (for example, wᵥ=4) input by the user in the n-level evaluation of the appearance preference information. The position of the user feature vector U₁ is corrected to a position that is an internally dividing point between the position of the appearance feature vector V₁ and the position of the appearance feature vector V₃ and considers the weighting based on the appearance preference information, by using Expression (1).

In a case where there is no user feature vector U₁ in the appearance vector space, the correction unit 15 defines the initial position of the user feature vector U₁ by Expression (1). The correction unit 15 stores the information of the user feature vector U₁ in the appearance vector space in the storage unit 11.

FIG. 5(b) is a diagram illustrating the correction of the position of the user feature vector in the detailed statement vector space. In FIG. 5(b), “ITEM A” indicates the position of the detailed statement feature vector D₁ of the smart phone C1, “ITEM B” indicates the position of the detailed statement feature vector D₃ of the smart phone C3, and “USER” indicates the position of the user feature vector U₂.

For example, the correction unit 15 corrects the position of the user feature vector U₂ in the detailed statement vector space by using the weighting w_{d} based on the detailed statement preference information. As an example, the correction unit 15 corrects the position of the user feature vector U₂ in the detailed statement vector space by using Expression (2) described below.

$$\{ {w}_{d} * {D}_{1} + ( n - {w}_{d} ) * {D}_{3} \} / n \qquad ( 2 )$$

Here, n is the total number of levels (for example, n=5) in the n-level evaluation of the detailed statement preference information. w_{d} is a level (for example, w_{d}=1) input by the user in the n-level evaluation of the detailed statement preference information. The position of the user feature vector U₂ is corrected to a position that is an internally dividing point between the position of the detailed statement feature vector D₁ and the position of the detailed statement feature vector D₃ and considers the weighting based on the detailed statement preference information, by using Expression (2).

In a case where there is no user feature vector U₂ in the detailed statement vector space, the correction unit 15 defines the initial position of the user feature vector U₂ by Expression (2). The correction unit 15 stores the information of the user feature vector U₂ in the detailed statement vector space in the storage unit 11.

Returning to FIG. 1, the computation unit 16 computes the score of each of the plurality of contents on the basis of a separation distance between the position of the user feature vector and the position of the content feature vector of the plurality of contents in the vector space. For example, the computation unit 16 computes a separation distance S_{V} between the position of the user feature vector and the position of the content feature vector of a certain content in the appearance vector space. In addition, the computation unit 16 computes a separation distance S_{D} between the position of the user feature vector and the position of the content feature vector of a certain content in the detailed statement vector space. The computation unit 16 computes the score (S_{V}+S_{D}) by adding the separation distance S_{V} in the appearance vector space and the separation distance S_{D} in the detailed statement vector space together. The score indicates that the position of the user feature vector and the position of the content feature vector in the vector space approach each other as the value decreases.

The output unit 17 outputs the recommendation result of the content selected on the basis of the score. For example, the output unit 17 selects one or a plurality of contents from the plurality of contents in ascending order of score, and transmits the recommendation result of the selected content to the user terminal 30.

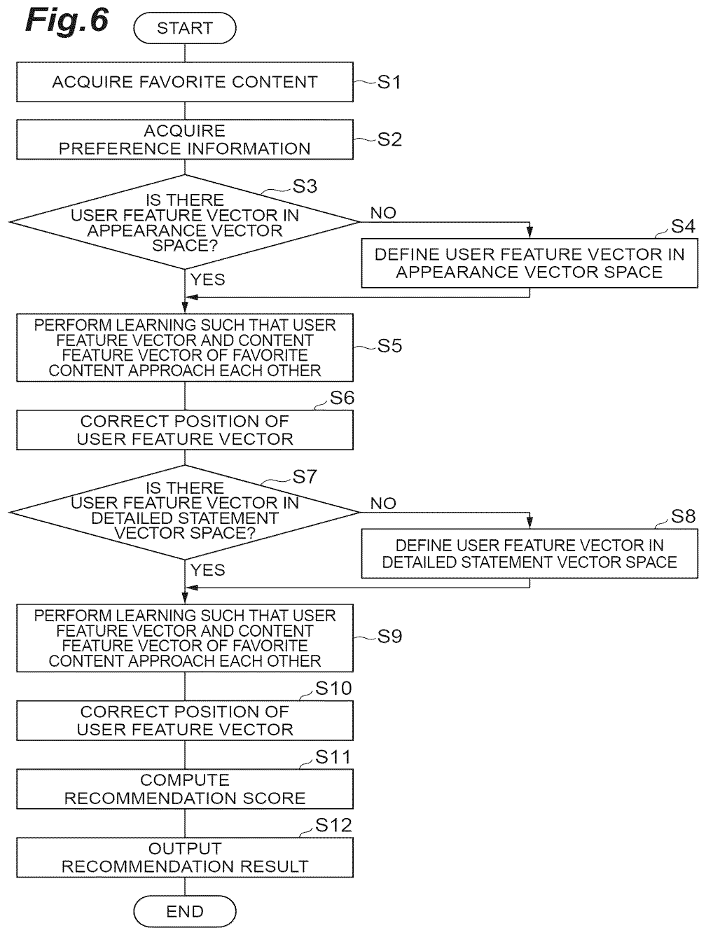

Next, processing executed by the recommendation device 10 will be described by using a flowchart illustrated in FIG. 6.

The acquisition unit 13 acquires the information indicating the plurality of favorite contents selected by the user from the plurality of contents (step S1). For example, the acquisition unit 13 acquires the information indicating the plurality of favorite contents selected by the user via the product selection screen G1 illustrated in FIG. 3. For example, the acquisition unit 13 acquires the information indicating two favorite contents as the information indicating the plurality of favorite contents.

The acquisition unit 13 acquires the preference information indicating the preference of the user according to each of the plurality of favorite contents, which is input by the user comparing the plurality of favorite contents with each other (step S2). For example, the acquisition unit 13 acquires the preference information input by the user via the comparison screen G2 illustrated in FIG. 4. For example, the acquisition unit 13 acquires the appearance preference information as the preference information relevant to the appearance. In addition, the acquisition unit 13 acquires the detailed statement preference information as the preference information relevant to the detailed statement.

In a case where there is the user feature vector in the appearance vector space (YES in step S3), the processing proceeds to step S5. In a case where there is no user feature vector in the appearance vector space (NO in step S3), the processing proceeds to step S4.

The correction unit 15 defines the user feature vector in the appearance vector space (step S4). For example, the correction unit 15 defines the initial position of the user feature vector to the position that is the internally dividing point between the positions of the content feature vectors of the two favorite contents and considers the weighting based on the appearance preference information. In an example, the correction unit 15 defines the initial position of the user feature vector by Expression (1).

The learning unit 14 performs the learning such that in the appearance vector space, the position of the user feature vector and the position of the appearance feature vector of the plurality of favorite contents approach each other (step S5).

The correction unit 15 corrects the position of the user feature vector in the appearance vector space by using the weighting based on the appearance preference information (step S6). For example, the correction unit 15 corrects the position of the user feature vector to the position that is the internally dividing point between the positions of the content feature vectors of the two favorite contents and considers the weighting based on the appearance preference information. In an example, the correction unit 15 corrects the position of the user feature vector by Expression (1).

In a case where there is the user feature vector in the detailed statement vector space (YES in step S7), the processing proceeds to step S9. In a case where there is no user feature vector in the detailed statement vector space (NO in step S7), the processing proceeds to step S8.

The correction unit 15 defines the user feature vector in the detailed statement vector space (step S8). For example, the correction unit 15 corrects the initial position of the user feature vector to the position that is the internally dividing point between the positions of the content feature vectors of the two favorite contents and considers the weighting based on the detailed statement preference information. In an example, the correction unit 15 defines the initial position of the user feature vector by Expression (2).

The learning unit 14 performs the learning such that in the detailed statement vector space, the position of the user feature vector and the position of the detailed statement feature vector of the plurality of favorite contents approach each other (step S9).

The correction unit 15 corrects the position of the user feature vector in the detailed statement vector space by using the weighting based on the detailed statement preference information (step S10). For example, the correction unit 15 corrects the position of the user feature vector to the position that is the internally dividing point between the positions of the content feature vectors of the two favorite contents and considers the weighting based on the detailed statement preference information. In an example, the correction unit 15 corrects the position of the user feature vector by Expression (2).

The computation unit 16 computes the score of each of the plurality of contents on the basis of the separation distance between the position of the user feature vector and the position of the content feature vector of the plurality of contents in the vector space (step S11).

The output unit 17 outputs the recommendation result of the content selected on the basis of the score (step S12).

Next, the function effect of the recommendation device 10 according to this embodiment will be described.

The recommendation device 10 according to this embodiment includes the storage unit 11 storing the content feature vector indicating the feature of the content for each of the plurality of contents, and storing the user feature vector indicating the feature of the user, the acquisition unit 13 acquiring the information indicating the plurality of favorite contents selected by the user from the plurality of contents, and the preference information indicating the preference of the user according to each of the plurality of favorite contents, which is input by the user comparing the plurality of favorite contents with each other, the learning unit 14 performing the learning such that in the vector space indicating the content feature vector of the plurality of contents and the user feature vector, the position of the user feature vector and the position of the content feature vector of the plurality of favorite contents approach each other, the correction unit 15 correcting the position of the user feature vector in the vector space by using the weighting based on the preference information, the computation unit 16 computing the score of each of the plurality of contents on the basis of the separation distance between the position of the user feature vector and the position of the content feature vector of the plurality of contents in the vector space, and the output unit 17 outputting the recommendation result of the content selected on the basis of the score.

In the recommendation device 10 according to this embodiment, the information indicating the plurality of favorite contents selected by the user is acquired, and the preference information according to each of the plurality of favorite contents, which is input by the user comparing the plurality of favorite contents with each other, is acquired. Further, the learning is performed such that in the vector space, the position of the user feature vector and the position of the content feature vector of the plurality of favorite contents approach each other, and the position of the user feature vector is corrected by using the weighting based on the preference information. Then, the score is computed on the basis of the separation distance between the position of the user feature vector and the position of each of the content feature vectors, and the recommendation result of the content selected on the basis of the score is output. As described above, since the preference information of the user is acquired by the user selecting the favorite content from the plurality of contents and comparing the favorite contents with each other, it is possible to suitably grasp the preference information different for each of the users. Then, in addition to performing the learning such that the position of the user feature vector and the position of the content feature vector of the favorite content approach each other, by correcting the position of the user feature vector with the weighting based on the preference information described above, and selecting the recommendation target on the basis of the separation distance in the vector space, it is possible to sufficiently reflect the preference of the user, and recommend the content matching the preference of the user.

In the recommendation device 10 described above, the storage unit 11 stores the appearance feature vector as the content feature vector indicating the feature of the appearance for each of the plurality of contents. The acquisition unit 13 acquires the appearance preference information as the preference information relevant to the appearance. The learning unit 14 performs the learning such that in the appearance vector space that is the vector space indicating the appearance feature vector of the plurality of contents, the position of the user feature vector and the position of the appearance feature vector of the plurality of favorite contents approach each other. The correction unit 15 corrects the position of the user feature vector in the appearance vector space by using the weighting based on the appearance preference information. According to such a configuration, the preference information relevant to the appearance is reflected on the position of the user feature vector. As a result thereof, it is possible to more suitably grasp the preference information different for each of the users.

In the recommendation device 10 described above, the storage unit 11 stores the detailed statement feature vector as the content feature vector indicating the feature for the detailed statement of each of the plurality of contents. The acquisition unit 13 acquires the detailed statement preference information as the preference information relevant to the detailed statement. The learning unit 14 performs the learning such that in the detailed statement vector space that is the vector space indicating the detailed statement feature vector of the plurality of contents, the position of the user feature vector and the position of the detailed statement feature vector of the plurality of favorite contents approach each other. The correction unit 15 corrects the position of the user feature vector in the detailed statement vector space by using the weighting based on the detailed statement preference information. According to such a configuration, the preference information relevant to the detailed statement is reflected on the position of the user feature vector. As a result thereof, it is possible to more suitably grasp the preference information different for each of the users.

In the recommendation device 10 described above, the acquisition unit 13 acquires the information indicating two favorite contents as the information indicating the plurality of favorite contents. The correction unit 15 corrects the position of the user feature vector to the position that is the internally dividing point between the positions of the content feature vectors of the two favorite contents and considers the weighting based on the preference information. According to such a configuration, the position of the user feature vector is corrected between the positions of the content feature vectors of the two favorite contents. Accordingly, it is possible to specify to which of the two favorite contents the preference information of the user is inclined. In other words, it is possible to specify abstract preference such as the user saying that “I prefer this product”. Therefore, it is possible to suitably grasp the preference information different for each of the users.

In addition, in the recommendation device 10 described above, the preference information may be represented by using a gradual bias. The user terminal 30 may receive input in which the appearance preference information and the detailed statement preference information are evaluated in n levels, as with the comparison screen G2 illustrated in FIG. 3. Accordingly, the user is capable of visually adjusting a distance between the favorite contents. Further, it is easy to analyze the preference of the user.

### Modification Example

In the embodiment described above, an example has been described in which two favorite contents are selected as the plurality of favorite contents, but three or more favorite contents may be selected. In addition, in the embodiment described above, an example has been described in which the plurality of favorite contents are selected via the product selection screen G1, but the plurality of favorite contents, for example, may be selected by the user scanning the information of the product at the store by using the user terminal 30.

In the embodiment described above, the appearance preference information and the detailed statement preference information have been described as the example of the preference information, but the preference information may be either the appearance preference information or the detailed statement preference information, or may be different preference information or a combination thereof.

In the embodiment described above, the computation unit 16 computes the score (S_{V}+S_{D}) by adding the separation distance S_{V} in the appearance vector space and the separation distance S_{D} in the detailed statement vector space together, but may perform the weighting of the score. For example, the acquisition unit 13 may further acquire valuing information indicating which of the appearance and the detailed statement according to the content the user values. The valuing information may be a fixed value, or may be a variable. The computation unit 16 may compute the score by using weighting based on the valuing information.

Note that, a block diagram used for the description of the above embodiment illustrates the blocks of function units. Such function blocks (configuration units) are attained by any combination of at least one of hardware and software. In addition, a method for attaining each of the function blocks is not particularly limited. That is, each of the function blocks may be attained by using one physically or logically coupled device, or may be attained by using a plurality of devices obtained by directly or indirectly (for example, in a wired or wireless manner) connecting two or more devices physically or logically separated from each other. The function block may be attained by combining software with the one device or the plurality of devices.

The function includes determining, judging, calculating, computing, processing, deriving, investigating, searching, ascertaining, receiving, transmitting, outputting, accessing, resolving, selecting, choosing, establishing, comparing, assuming, expecting, regarding, broadcasting, notifying, communicating, forwarding, configuring, reconfiguring, allocating, mapping, assigning, and the like, but is not limited thereto. For example, the function block (the configuration unit) performing the transmitting is referred to as a transmitting unit or a transmitter. In either case, as described above, a method for attaining the function block is not particularly limited.

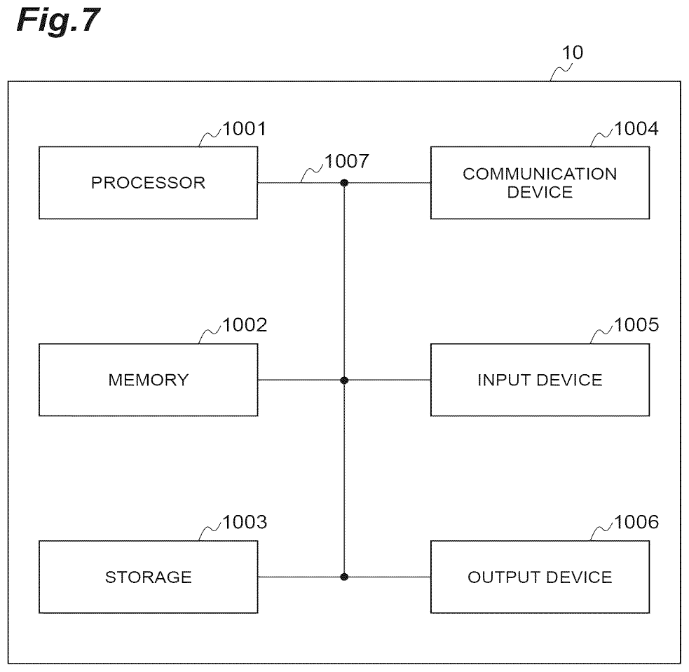

For example, the recommendation device 10 in one embodiment of the present disclosure may function as a computer performing information processing of the present disclosure. FIG. 7 is a diagram illustrating an example of a hardware configuration of the recommendation device 10 according to one embodiment of the present disclosure. The recommendation device 10 described above may be physically configured as a computer device including a processor 1001, a memory 1002, a storage 1003, a communication device 1004, an input device 1005, an output device 1006, a bus 1007, and the like. In addition, a hardware configuration of the user terminal 30 may also be the same as described herein.

Note that, in the following description, the word “device” can be replaced with a circuit, a unit, or the like. The hardware configuration of the recommendation device 10 may be configured to include one or a plurality of devices illustrated in the drawings, or configured to exclude some devices.

Each of the functions in the recommendation device 10 is attained by reading predetermined software (program) on the hardware such as the processor 1001 and the memory 1002 such that the processor 1001 performs arithmetic, and controlling the communication of the communication device 1004 or controlling at least one of the reading and the writing of data in the memory 1002 and the storage 1003.

The processor 1001, for example, controls the entire computer by operating an operating system. The processor 1001 may be composed of a central processing unit (CPU) including an interface with a peripheral device, a control device, an arithmetic device, a register, and the like. For example, each of the functions in the recommendation device 10 described above may be attained by the processor 1001.

In addition, the processor 1001 reads out a program (a program code), a software module, data, and the like from at least one of the storage 1003 and the communication device 1004 to the memory 1002, and executes various processing pieces in accordance with the program and the like. As the program, a program for allowing a computer to execute at least a part of the operation described in the above embodiment is used. For example, each of the functions in the recommendation device 10 may be attained by a control program that is stored in the memory 1002 and operated in the processor 1001. It has been described that the various processing pieces described above are executed by one processor 1001, but the various processing pieces may be simultaneously or sequentially executed by two or more processors 1001. The processor 1001 may be implemented by one or more chips. Note that, the program may be transmitted from a network via an electric communication line.

The memory 1002 is a computer-readable recording medium, and for example, may be composed of at least one of a read only memory (ROM), an erasable programmable ROM (EPROM), an electrically erasable programmable ROM (EEPROM), a random access memory (RAM), and the like. The memory 1002 may be referred to as a register, a cache, a main memory (a main storage device), and the like. The memory 1002 may store a program (a program code), a software module, and the like that can be executed to carry out the information processing according to one embodiment of the present disclosure.

The storage 1003 is a computer-readable recording medium, and for example, may be composed of at least one of an optical disk such as a compact disc ROM (CD-ROM), a hard disk drive, a flexible disk, a magnetooptic disk (for example, a compact disk, a digital versatile disk, and a Blu-ray (Registered Trademark) disk), a smart card, a flash memory (for example, a card, a stick, and a key drive), a floppy (Registered Trademark) disk, a magnetic strip, and the like. The storage 1003 may be referred to as an auxiliary storage device. A storage medium provided in the recommendation device 10, for example, may be a database, a server, and other suitable media including at least one of the memory 1002 and the storage 1003.

The communication device 1004 is hardware (a transmitting and receiving device) for performing communication with respect to a computer via at least one of a wired network and a wireless network, and for example, is also referred to as a network device, a network controller, a network card, a communication module, and the like.

The input device 1005 is an input device (for example, a keyboard, a mouse, a microphone, a switch, a button, a sensor, and the like) receiving input from the outside. The output device 1006 is an output device (for example, a display, a speaker, an LED lamp, and the like) carrying out output to the outside. Note that, the input device 1005 and the output device 1006 may have an integrated configuration (for example, a touch panel).

In addition, each of the devices such as the processor 1001 and

the memory 1002 is connected by the bus 1007 for performing the communication of the information. The bus 1007 may be configured by using a single bus, or may be configured by using different buses for each of the devices.

In addition, the recommendation device 10 may be configured by including hardware such as a microprocessor, a digital signal processor (DSP), an application specific integrated circuit (ASIC), a programmable logic device (PLD), and a field programmable gate array (FPGA), and a part or all of each of the function blocks may be attained by the hardware. For example, the processor 1001 may be implemented by using at least one of the hardware.

The order of the processing procedure, the sequence, the flowchart, and the like of each of the aspects/embodiments described in the present disclosure may be changed unless there is contradiction. For example, in the method described in the present disclosure, the elements of various steps are presented by using an exemplary order, but the present disclosure is not limited to the presented specific order.

The input and output information or the like may be stored in a specific place (for example, a memory), or may be managed by using a management table. The input and output information or the like can be overwritten, updated, or edited. The output information or the like may be deleted. The input information or the like may be transmitted to other devices.

The judging may be performed by a value represented by 1 bit (0 or 1), may be performed by a truth value (Boolean: true or false), or may be performed by comparing numerical values (for example, comparing with a predetermined value).

Each of the aspects/embodiments described in the present disclosure may be used alone, may be used in combination, or may be used by being switched in accordance with the execution. In addition, the notifying of predetermined information (for example, the notifying of “X”) is not limited to being performed explicitly, but may be performed implicitly (for example, by not performing the notifying of the predetermined information).

The present disclosure has been described in detail, but it is obvious to a person skilled in the art that the present disclosure is not limited to the embodiment described in the present disclosure. The present disclosure can be carried out as modifications and variations without departing from the spirit and the scope of the present disclosure defined by the claims. Therefore, the description of the present disclosure is for illustrative purpose and is not intended to have any restrictive meaning on the present disclosure.

The software should be broadly construed to indicate an instruction, an instruction set, a code, a code segment, a program code, a program, a sub-program, a software module, an application, a software application, a software package, a routine, a sub-routine, an object, an executable file, an execution thread, a procedure, a function, and the like, regardless of being referred to as software, firmware, middleware, a microcode, and a hardware description language, or referred to as other names.

In addition, the software, the instruction, the information, and the like may be transmitted and received via a transmission medium. For example, in a case where the software is transmitted from a website, a server, or other remote sources by using at least one of a wired technology (a coaxial cable, an optical fiber cable, a twisted pair, a digital subscriber line (DSL), and the like) and a wireless technology (an infrared ray, a microwave, and the like), at least one of the wired technology and the wireless technology is included in the definition of the transmission medium.

The terms “system” and “network” used in the present disclosure are used interchangeably.

In addition, the information, the parameter, and the like described in the present disclosure may be represented by using an absolute value, may be represented by using a relative value from a predetermined value, or may be represented by using another corresponding information.

The term “determining” used in the present disclosure may include various operations. “Determining”, for example, may include considering judging, calculating, computing, processing, deriving, investigating, search (looking up or inquiry) (for example, search in a table, a database, or another data structure), and ascertaining as “determining”. In addition, “determining” may include considering receiving (for example, receiving information), transmitting (for example, transmitting information), input, output, and accessing (for example, accessing data in a memory) as “determining”. In addition, “determining” may include considering resolving, selecting, choosing, establishing, comparing, and the like as “determining”. That is, “determining” may include “determining” any operation. In addition, “determining” may be replaced with “assuming”, “expecting”, “considering”, and the like.

The terms “connected” and “coupled”, or any variations thereof indicate any direct or indirect connection or coupling between two or more elements, and may include one or more intermediate elements between two elements “connected” or “coupled” to each other. The elements may be coupled or connected to each other physically, logically, or in combination thereof. For example, “connecting” may be replaced with “accessing”. In a case where the terms are used in the present disclosure, it can be considered that two elements are “connected” or “coupled” to each other by using at least one of one or more electric wires, cables, and printed electric connections, and as several non-determinative and non-inclusive examples, by using electromagnetic energy or the like having a wavelength in a wireless frequency region, a microwave region, and a light (both of visible and non-visible) region.

The expression “on the basis of” used in the present disclosure does not indicate “only on the basis of” unless explicitly stated otherwise. In other words, the expression “on the basis of” indicates both of “only on the basis of” and “at least on the basis of”.

Any reference to the elements using the addresses “first”, “second”, and the like used in the present disclosure does not generally limit the amount or the order of the elements. Such addresses can be used in the present disclosure as a convenient method for distinguishing two or more elements. Therefore, the reference to the first and second elements does not indicate that only two elements can be adopted or the first element necessarily precedes the second element in any way.

In the present disclosure, in a case where “include”, “including”, and variations thereof are used, such terms are intended to be inclusive as with the term “comprising”. Further, the term “or” used in the present disclosure is intended not to be exclusive OR.

In the present disclosure, for example, in a case where articles are added by translation, such as a, an, and the in English, the present disclosure may include that the nouns following such articles are in a plural form.

In the present disclosure, the term “A and B are different” may indicate that “A and B are different from each other”. Note that, the term may indicate that “each of A and B is different from C”. The terms “separated”, “coupled”, and the like may be construed as with “different”.

### REFERENCE SIGNS LIST

10: recommendation device, 11: storage unit, 12: screen management unit, 13: acquisition unit, 14: learning unit, 15: correction unit, 16: computation unit, 17: output unit, 21: content feature vector, 22: user feature vector.

1. A recommendation device, comprising:
a storage unit storing a content feature vector indicating a feature of a content for each of a plurality of contents, and storing a user feature vector indicating a feature of a user;
an acquisition unit acquiring information indicating a plurality of favorite contents selected by the user from the plurality of contents, and preference information indicating preference of the user according to each of the plurality of favorite contents, which is input by the user comparing the plurality of favorite contents with each other;
a learning unit performing learning such that in a vector space indicating the content feature vector of the plurality of contents and the user feature vector, a position of the user feature vector and a position of the content feature vector of the plurality of favorite contents approach each other;
a correction unit correcting the position of the user feature vector in the vector space by using weighting based on the preference information;
a computation unit computing a score of each of the plurality of contents on the basis of a separation distance between the position of the user feature vector and the position of the content feature vector of the plurality of contents in the vector space; and
an output unit outputting a recommendation result of a content selected on the basis of the score.

2. The recommendation device according to claim 1,
wherein the storage unit stores an appearance feature vector as the content feature vector indicating a feature of an appearance for each of the plurality of contents,
the acquisition unit acquires appearance preference information as the preference information relevant to the appearance,
the learning unit performs learning such that in an appearance vector space that is the vector space indicating the appearance feature vector of the plurality of contents, the position of the user feature vector and a position of the appearance feature vector of the plurality of favorite contents approach each other, and
the correction unit corrects the position of the user feature vector in the appearance vector space by using weighting based on the appearance preference information.

3. The recommendation device according to claim 1,
wherein the storage unit stores a detailed statement feature vector as the content feature vector indicating a feature of a detailed statement of each of the plurality of contents,
the acquisition unit acquires detailed statement preference information as the preference information relevant to the detailed statement,
the learning unit performs learning such that in a detailed statement vector space that is the vector space indicating the detailed statement feature vector of the plurality of contents, the position of the user feature vector and a position of the detailed statement feature vector of the plurality of favorite contents approach each other, and
the correction unit corrects the position of the user feature vector in the detailed statement vector space by using weighting based on the detailed statement preference information.

4. The recommendation device according to claim 1,
wherein the acquisition unit acquires information indicating two of the favorite contents as the information indicating the plurality of favorite contents, and
the correction unit corrects the position of the user feature vector to a position that is an internally dividing point between the positions of the content feature vectors of the two favorite contents and considers the weighting based on the preference information.

5. The recommendation device according to claim 2,
wherein the storage unit stores a detailed statement feature vector as the content feature vector indicating a feature of a detailed statement of each of the plurality of contents,
the acquisition unit acquires detailed statement preference information as the preference information relevant to the detailed statement,
the learning unit performs learning such that in a detailed statement vector space that is the vector space indicating the detailed statement feature vector of the plurality of contents, the position of the user feature vector and a position of the detailed statement feature vector of the plurality of favorite contents approach each other, and
the correction unit corrects the position of the user feature vector in the detailed statement vector space by using weighting based on the detailed statement preference information.

6. The recommendation device according to claim 2,
wherein the acquisition unit acquires information indicating two of the favorite contents as the information indicating the plurality of favorite contents, and
the correction unit corrects the position of the user feature vector to a position that is an internally dividing point between the positions of the content feature vectors of the two favorite contents and considers the weighting based on the preference information.

7. The recommendation device according to claim 3,
wherein the acquisition unit acquires information indicating two of the favorite contents as the information indicating the plurality of favorite contents, and
the correction unit corrects the position of the user feature vector to a position that is an internally dividing point between the positions of the content feature vectors of the two favorite contents and considers the weighting based on the preference information.
